(19) United States
(12) Patent Application Publication
(10) Pub. No.: US 2014/0068128 A1
(43) Pub. Date: Mar. 6, 2014

(54) STREAM PROCESSOR

(71) Applicant: PANASONIC CORPORATION, Osaka (JP)

(72) Inventor: Taro MAEDA, Kyoto (JP)

(73) Assignee: PANASONIC CORPORATION, Osaka (JP)

(21) Appl. No.: 14/074,418

(22) Filed: Nov. 7, 2013

Related U.S. Application Data
(63) Continuation of application No. PCT/JP2011/007175, filed on Dec. 21, 2011.

(30) Foreign Application Priority Data
May 17, 2011 (JP) 2011-110603

(51) Int. Cl. G06F 13/16

(52) U.S. Cl. CPC G06F 13/1605
USPC 710/244

(57) ABSTRACT

A stream processor that accesses a memory includes: stream processing sections each configured to extract a time stamp in an associated one of input streams, obtain priority information on access to the memory based on a difference between the time stamp and a reference time, output an access request to the memory and the priority information, and, when receiving access permission, access the memory; and an access controller configured to grant access permission to the stream processing sections repeatedly based on the access request and the priority information in such a manner that the access controller grants access permission to one of the stream processing sections having a highest priority and then, after termination of processing of the stream processing section to which the access permission has been granted, grants access permission to one of the stream processing sections having a next highest priority.

### CROSS-REFERENCE TO RELATED APPLICATIONS

This is a continuation of International Application No. PCT/JP2011/007175 filed on Dec. 21, 2011, which claims priority to Japanese Patent Application No. 2011-110603 filed on May 17, 2011. The entire disclosures of these applications are incorporated by reference herein.

### BACKGROUND

The present disclosure relates to a stream processor for processing a plurality of streams.

With recently enhanced function of digital audiovisual (AV) equipment, the number of functions and applications that are used at a time has been increasing. To catch up this situation, it has been required for a single system-on-a-chip (SOC) to process a plurality of streams at a time. It is also required to reduce hardware resources, e.g., main memories, in order to reduce the cost for the equipment. For this reason, development of SOCs for digital AV equipment encounters a problem of insufficient performance of hardware due to bandwidth shortage of main memories. It is therefore important to design a circuit with a reduced main memory bandwidth that is needed.

An SOC includes a plurality of masters that access a main memory. A main memory bandwidth necessary for each of the masters is defined at system start-up or switching of operation of a system. Each of the masters performs processing using an associated one of the bandwidths. It can be determined that the system is effective unless the sum of the bandwidths exceeds the main memory bandwidth. In this case, it is necessary to control access from the masters to the main memory. Japanese Patent Publication No. 2003-186823 describes a system that controls the order of priority of access to a slave device.

### SUMMARY

A technique of allocating a main memory bandwidth at, e.g., system start-up, however, cannot dynamically control the bandwidth according to the content of received streams, and thus, is not suitable for such a system that processes various types of streams by using a common hardware resource. There are a large number of types of streams for different purposes of hardware, such as small amounts of subtitle data and menu data, as well as audio streams and video streams that need to be processed in real time. For example, subtitle data starts being input in small pieces at each time shortly before an associated piece of video data is input, and thus, only needs to be processed in small pieces at each time. On the other hand, menu data suddenly appears at random by means of operation of an end user, and needs to be displayed at a speed as high as possible. In a case where it is required to further enhance hardware performance in order to display such menu data, the main memory bandwidth needs to be large beyond that required in consideration of a loss of an opportunity for access to a main memory by other processing.

It is therefore an object of the present disclosure to use a memory bandwidth efficiently in processing a plurality of streams.

An example stream processor according to the present disclosure is a stream processor that accesses a memory and includes: a plurality of stream processing sections each configured to extract a time stamp in an associated one of input streams received by the stream processing sections, obtain priority information on access to the memory based on a difference between the time stamp and a reference time, output an access request to the memory and the priority information, and, when receiving access permission, access the memory; and an access controller configured to grant access permission to the stream processing sections repeatedly based on the access request and the priority information in such a manner that the access controller grants access permission to one of the stream processing sections having a highest priority and then, after termination of processing of the stream processing section to which the access permission has been granted, grants access permission to one of the stream processing sections having a next highest priority.

In this configuration, priority information on access to the memory is obtained based on the time stamps extracted from the input streams, and based on the priority information, access permission is granted to the stream processing section having the highest priority. After termination of processing of the stream processing section to which the access permission has been granted, access permission is granted to the stream processing section having the next highest priority, thereby obtaining results of stream processing in the order of priority.

According to the present disclosure, access to a memory is controlled by using time stamps in input streams, thereby enabling efficient use of a memory bandwidth in processing a plurality of streams.

### BRIEF DESCRIPTION OF THE DRAWINGS

FIG. 1 is a block diagram illustrating an example configuration of a stream processor according to an embodiment of the present disclosure.

FIG. 2 is a timing chart showing an example of transfer to a main memory by using a conventional stream processor.

FIG. 3 is a timing chart showing an example of transfer to a main memory by using the stream processor illustrated in FIG. 1.

FIG. 4 is a block diagram illustrating a variation of the configuration of the stream processor illustrated in FIG. 1.

FIG. 5 is a timing chart showing an example of transfer to a main memory by using a stream processor illustrated in FIG. 4.

FIG. 6 is a block diagram illustrating another variation of the configuration of the stream processor illustrated in FIG. 1.

FIG. 7 is a block diagram illustrating still another variation of the configuration of the stream processor illustrated in FIG. 1.

FIG. 8 is a timing chart showing an example of clock control by using the stream processor illustrated in FIG. 7.

### DETAILED DESCRIPTION

An embodiment of the present disclosure will be described hereinafter with reference to the drawings. In the drawings, reference numerals having the same last two digits designate the same or similar elements.

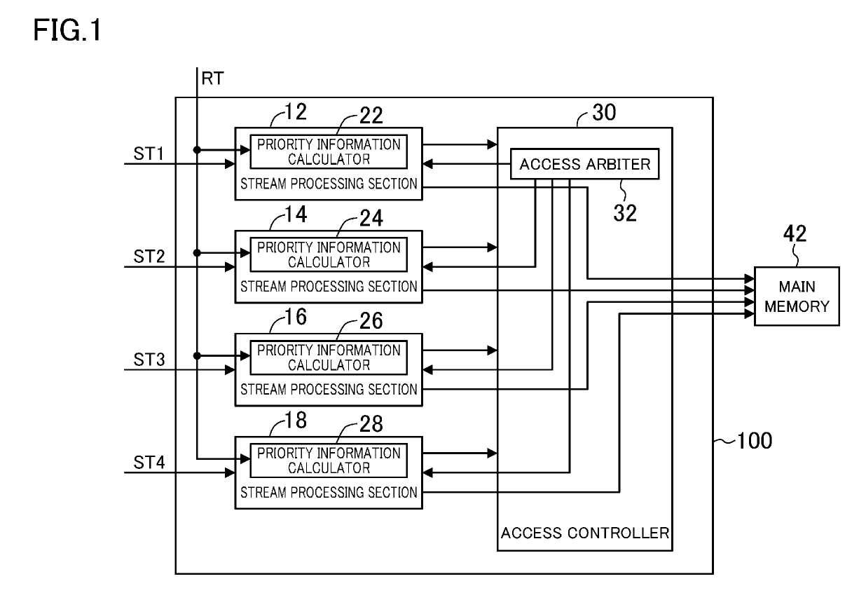

FIG. 1 is a block diagram illustrating an example configuration of a stream processor according to an embodiment of the present disclosure. A stream processor 100 illustrated in FIG. 1 includes stream processing sections 12, 14, 16, and 18 and an access controller 30. The processing sections 12, 14, 16, and 18 include priority information calculators 22, 24, 26, and 28, respectively. The access controller 30 includes an access arbiter 32. The stream processing sections 12, 14, 16, and 18 receive streams ST1, ST2, ST3, and ST4, respectively. The stream processing sections 12, 14, 16, and 18 perform menu decoding A, subtitle decoding B, menu decoding C, and subtitle decoding D, respectively.

The priority information calculator 22 extracts time stamp information on a menu to be displayed, from the stream ST1. Examples of the time stamp include a presentation time stamp (PTS) and a decoding time stamp (DTS). The priority information calculator 22 calculates the difference between the extracted time stamp and a reference time RT, and outputs the obtained difference to a main memory 42 as an access priority. In this calculation, the priority information calculator 22 subtracts the reference time RT from the extracted time stamp, for example. The reference time RT is, for example, a system time clock (STC), and input from a CPU (not shown). The stream processing section 12 adds the priority obtained by the priority information calculator 22 to an access request to the main memory 42, and outputs the resulting access request to the access controller 30.

Similarly, the priority information calculators 24 and 28 acquire time stamps of subtitles to be displayed, from the streams ST2 and ST4, respectively. The priority information calculator 26 acquires a time stamp of a menu to be displayed, from the stream ST3. Each of the priority information calculators 24, 26, and 28 calculates the difference between the acquired time stamp and the reference time RT, and outputs the obtained difference as priority information of access to the main memory 42. The priority increases as the value of the priority information decreases. Each of the stream processing sections 14, 16, and 18 adds the priority information obtained by an associated one of the priority information calculators 24, 26, and 28 to the access request to the main memory 42, and outputs the resulting priority information to the access controller 30.

The access arbiter 32 determines which one of the stream processing sections 12, 14, 16, and 18 is to receive access permission, based on the priority information from the stream processing sections 12, 14, 16, and 18. Specifically, for example, the access arbiter 32 determines that access permission should be granted to the stream processing section 12 having the highest priority (i.e., having the smallest value of priority information), and grants access permission to the stream processing section 12. The stream processing section 12 that has received the access permission accesses the main memory 42.

Then, after the processing of the stream processing section 12 that received the access permission has terminated, the access arbiter 32 grants access permission to a stream processing section (e.g., the stream processing section 14) having the next highest priority (the second smallest value of priority information) after the stream processing section 12 that has finished its processing. The stream processing section 14 that has received the access permission accesses the main memory 42. Subsequently, after the processing of the stream processing section that received the access permission has terminated, the access arbiter 32 grants access permission to a stream processing section having the next highest priority after the stream processing section that has finished its processing, and this process is repeatedly performed.

In this manner, the access arbiter 32 makes determination based on the priority order, and thereby, a plurality of streams can be processed with dynamic determination of streams to be processed by priority.

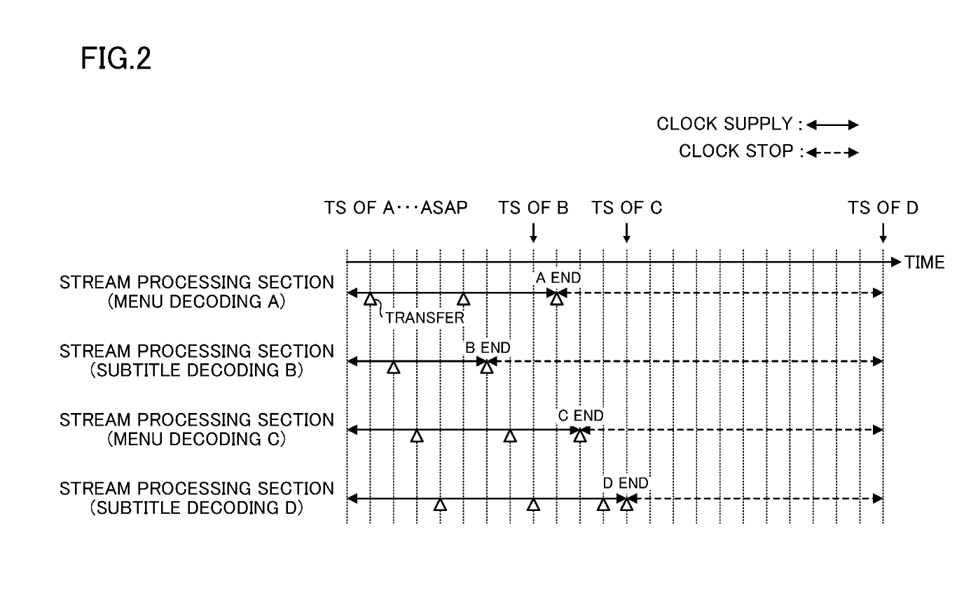

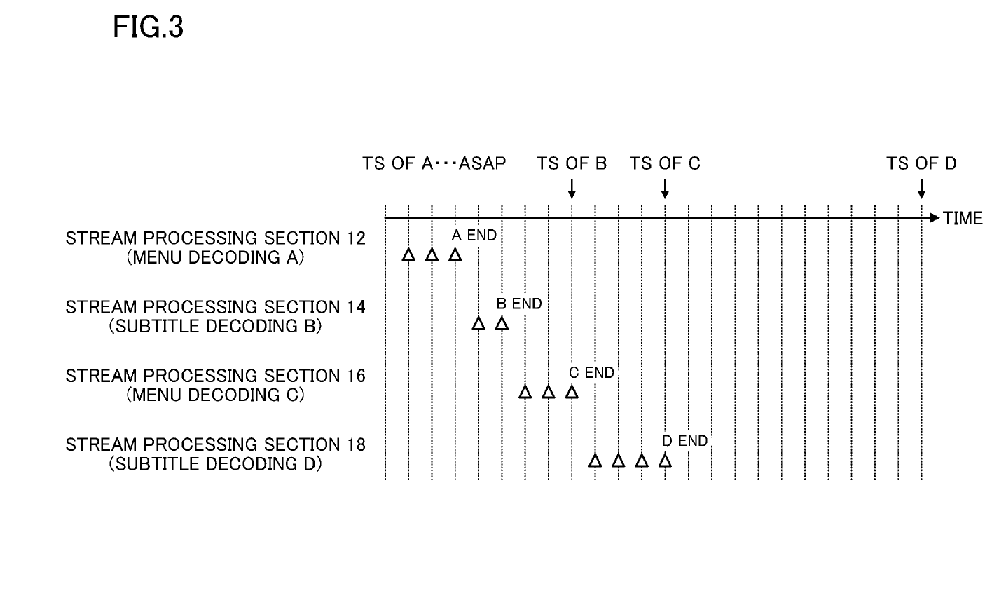

FIG. 2 is a timing chart showing an example of transfer to a main memory by using a conventional stream processor. FIG. 3 is a timing chart showing an example of transfer to the main memory by using the stream processor 100 illustrated in FIG. 1.

In FIGS. 2 and 3, the vertical broken lines indicate timings when the main memory 42 is accessed by the whole stream processor. The distance between the broken lines corresponds to the main memory bandwidth (the transfer bandwidth to the main memory 42) allocated to the whole stream processor. The timing charts show that the time stamp (TS) of the menu decoding A should be performed as soon as possible. In this case, the time stamp is considered to coincide with, for example, the reference time RT. The time stamps of the subtitle decoding B, the menu decoding C, and the subtitle decoding D are also shown in the timing charts. In the menu decoding A, the subtitle decoding B, the menu decoding C, and the subtitle decoding D, transfer to the main memory 42 needs to be performed three times, twice, three times, and four times, respectively. The same holds for the timing charts that will be referred to later.

The process of FIG. 2 employs a round robin scheduling as an arbitration technique. In this case, transfer for the menu decoding A that needs to be finished earliest is completed after transfer for the subtitle decoding B. That is, in typical arbitration in direct memory access (DMA) such as a round robin, the relationship between a completion required time indicated by a time stamp and an actual completion time is not necessarily rational. On the other hand, in the case of FIG. 3, the transfer for the menu decoding A is finished earliest, and thus, the relationship between the completion required time and the actual completion time is rational. Accordingly, the stream processor 100 illustrated in FIG. 1 can achieve predetermined performance even with a small available main memory bandwidth.

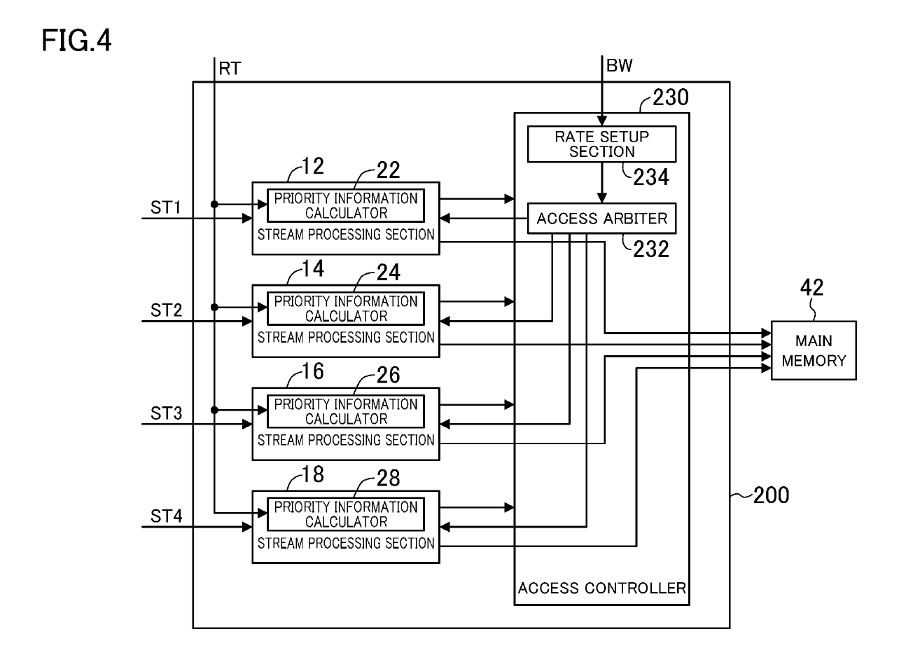

FIG. 4 is a block diagram illustrating a variation of the configuration of the stream processor 100 illustrated in FIG. 1. A stream processor 200 illustrated in FIG. 4 has the same configuration as that of the stream processor 100 except for including an access controller 230 instead of the access controller 30. The access controller 230 includes an access arbiter 232 and a rate setup section 234.

The rate setup section 234 receives, from, e.g., a CPU, a bandwidth BW of the main memory 42 with respect to each of the stream processing sections 12, 14, 16, and 18. The bandwidth BW is a bandwidth necessary for processing streams to be input to each of the stream processing sections 12, 14, 16, and 18. The rate setup section 234 outputs the received bandwidth BW to the access arbiter 232. The access arbiter 232 grants access permission based on the bandwidth from the rate setup section 234 in addition to priority information from the stream processing sections 12, 14, 16, and 18.

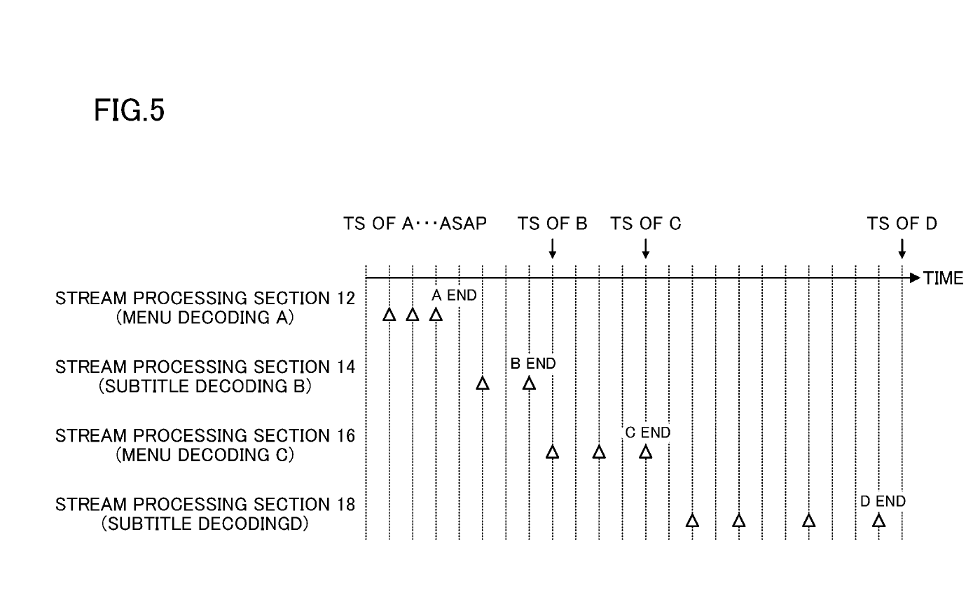

FIG. 5 is a timing chart showing an example of transfer to the main memory by using the stream processor 200 illustrated in FIG. 4. Specifically, the access arbiter 232 reduces uneven temporal distribution of access in a case where the bandwidth from the rate setup section 234 is satisfied without transfer at every broken line in FIG. 5. The access arbiter 232 grants access permission to the stream processing section 18 once for every second or third broken line in FIG. 5, as in the case of subtitle decoding D in FIG. 5.

In FIG. 3, access to the main memory is continuously performed until completion of transfer for the subtitle decoding D in a case where a plurality of stream processings conflict with one another. On the other hand, in FIG. 5, while conditions of the completion time required for each stream processing are satisfied, access to the main memory is not issued at some times. In this manner, in the stream processor 200, at times when the stream processing sections 12, 14, 16, and 18 do not perform transfer, the main memory 42 can be accessed by another circuit such as a CPU, thereby enhancing performance of the entire system.

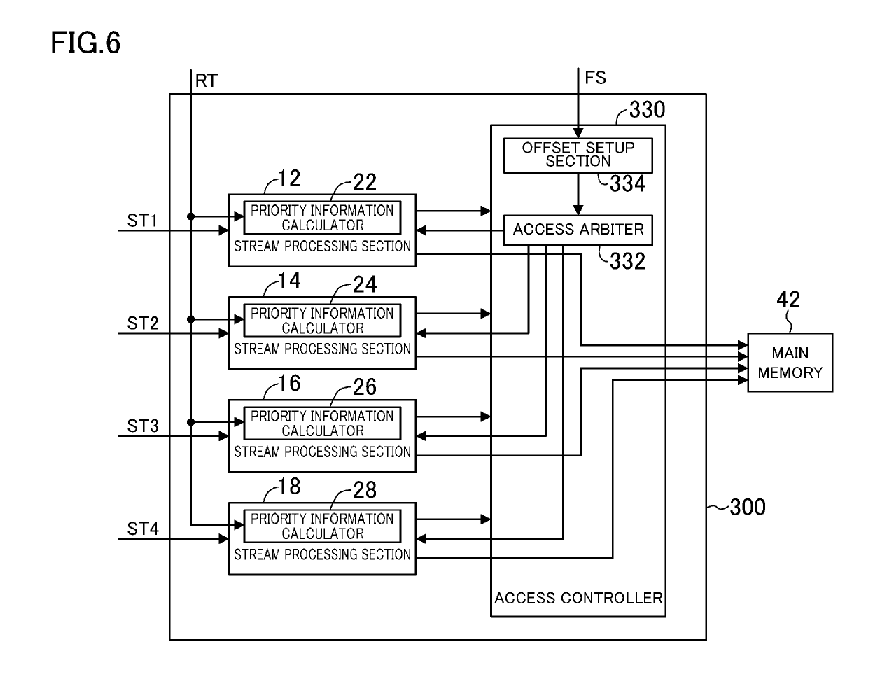

FIG. 6 is a block diagram illustrating another variation of the configuration of the stream processor 100 illustrated in FIG. 1. A stream processor 300 illustrated in FIG. 6 has the same configuration as that of the stream processor 100 except for including an access controller 330 instead of the access controller 30. The access controller 330 includes an access arbiter 332 and an offset setup section 334.

The offset setup section 334 receives, from, e.g., a CPU, an offset FS for the priority of each of the stream processing sections 12, 14, 16, and 18. The offset setup section 334 outputs the received offset FS to the access arbiter 332. The access arbiter 332 grants access permission based on the offset from the offset setup section 334 in addition to the priority information from the stream processing sections 12, 14, 16, and 18. At this time, the access arbiter 332 uses priority information that has been changed based on the offset FS input to the offset setup section 334. Specifically, for example, the access arbiter 332 adds the offset FS to the priority information of the stream processing section 12, 14, 16 or 18, and uses the resulting information. The stream processor 300 enables adjustment of the priority for each stream depending on operating characteristics of, for example, a CPU or a drawing engine at a subsequent stage.

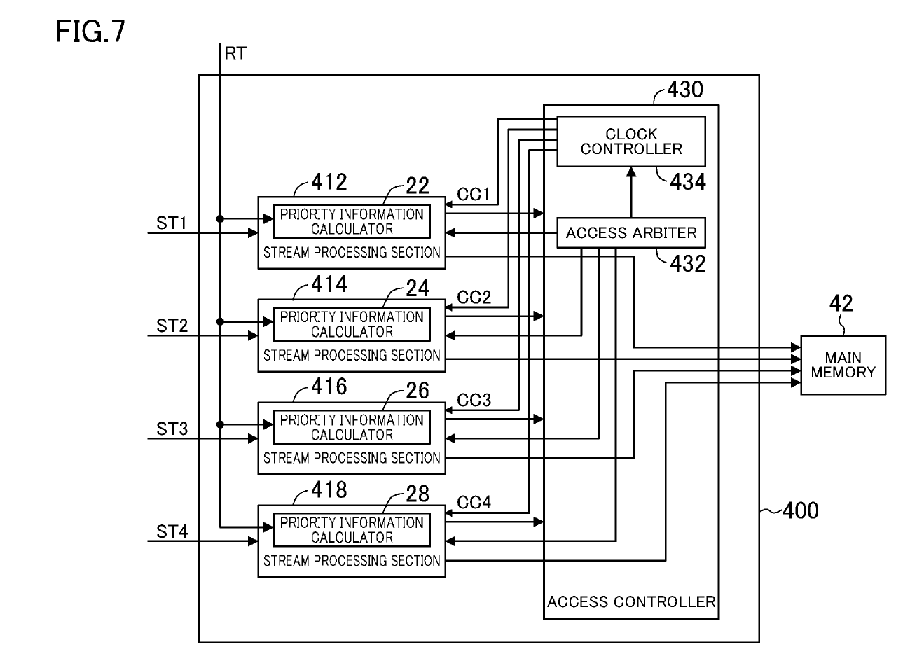

FIG. 7 is a block diagram illustrating still another variation of the configuration of the stream processor 100 illustrated in FIG. 1. A stream processor 400 illustrated in FIG. 7 has the same configuration as that of the stream processor 100 except for including stream processing sections 412, 414, 416, and 418 instead of the stream processing sections 12, 14, 16, and 18, and including an access controller 430 instead of the access controller 30. The access controller 430 includes an access arbiter 432 and a clock controller 434.

The stream processing sections 412, 414, 416, and 418 perform clock gating control therein based on received clock control signals CC1, CC2, CC3, and CC4. The other part of the configuration is similar to that of the stream processing sections 12, 14, 16, and 18 of FIG. 1. The access arbiter 432 notifies the clock controller 434 of which one of the stream processing sections 412, 414, 416, and 418 access permission is granted to. The other part of the configuration of the access arbiter 432 is similar to that of the access arbiter 32 of FIG. 1.

The clock controller 434 outputs the clock control signal CC1, CC2, CC3, or CC4 instructing each one of the stream processing sections 412, 414, 416, and 418 to which no access permission is granted to stop a clock while no access permission is being granted. The stream processing section 412, 414, 416, or 418 that has been instructed to stop a clock based on the clock control signal CC1, CC2, CC3, or CC4 stops at least one of the clocks that are being used in the stream processing section 412, 414, 416, or 418. In this manner, dynamic clock gating control is performed on the stream processing section that does not receive access permission, thereby reducing power consumption. The stream processor 200 or 300 illustrated in FIG. 4 or 6 may include the clock controller 434 to control clocks in the same manner.

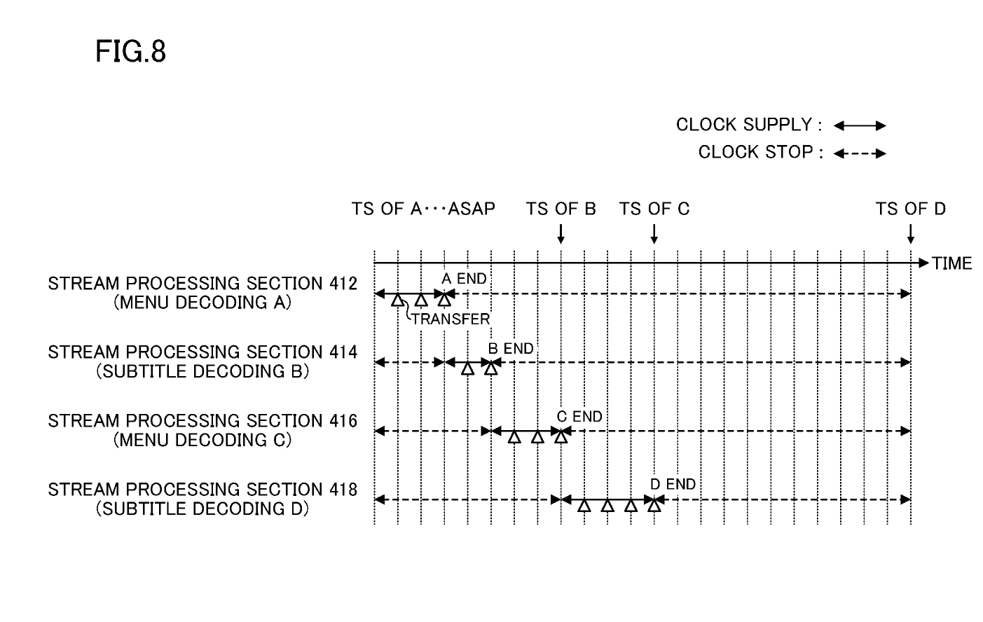

FIG. 8 is a timing chart showing an example of clock control by the stream processor 400 illustrated in FIG. 7. Each of the stream processing sections is supplied with clocks from when decoding is started in response to access permission to when transfer is finished. The timing chart of FIG. 8 shows that a period in which clocks are supplied is shorter and power consumption is reduced more greatly in the case of FIG. 8 than in the case of FIG. 2. This is because until transfer for one processing is finished, a clock of the stream processing section that is in charge of this processing cannot be stopped.

In the foregoing embodiment, the stream processor includes four stream processing sections. Alternatively, the number of stream processing sections is not limited to the above example. Each of the stream processing sections may process video streams and/or audio streams. Instead of the main memory, access to another memory may be controlled in a manner similar to that described above.

Each functional block herein can be typically implemented as hardware. For example, each functional block may be implemented on a semiconductor substrate as a part of an integrated circuit (IC). Here, an IC includes a large-scale integrated circuit (LSI), an application-specific integrated circuit (ASIC), a gate array, a field programmable gate array (FPGA), etc. Alternatively, a part or the entire part of each functional block may be implemented as software. For example, such a functional block may be implemented by a processor and a program that can be executed on the processor. In other words, each functional block herein may be implemented as hardware, software, or any combination of hardware and software.

The many features and advantages of the present disclosure are apparent from the detailed specification and, thus, it is intended by the appended claims to cover all such features and advantages of the present disclosure which fall within the true spirit and scope of the invention. Further, since numerous modifications and changes will readily occur to those skilled in the art, it is not desired to limit the present disclosure to the exact construction and operation illustrated and described, and accordingly all suitable modifications and equivalents may be resorted to, falling within the scope of the invention.

As described above, according to the present disclosure, a memory bandwidth can be used efficiently in processing a plurality of streams, and thus, the present disclosure is useful for, for example, stream processors.

What is claimed is:

1. A stream processor that accesses a memory, the stream processor comprising:
a plurality of stream processing sections each configured to extract a time stamp in an associated one of input streams received by the stream processing sections, obtain priority information on access to the memory based on a difference between the time stamp and a reference time, output an access request to the memory and the priority information, and, when receiving access permission, access the memory; and
an access controller configured to grant access permission to the stream processing sections repeatedly based on the access request and the priority information in such a manner that the access controller grants access permission to one of the stream processing sections having a highest priority and then, after termination of processing of the stream processing section to which the access permission has been granted, grants access permission to one of the stream processing sections having a next highest priority.

2. The stream processor of claim 1, wherein
the access controller grants access permission to the stream processing sections based on transfer bandwidths to the memory necessary for processing of the input streams, in addition to the access request and the priority information.

3. The stream processor of claim 1, wherein
the access controller changes the priority information based on an input offset and uses priority information that has been changed.

4. The stream processor of claim 1, wherein
the access controller includes a clock controller configured to output a clock control signal instructing each one of the stream processing sections to which no access permission has been granted to stop a clock while no access permission is being granted, and
the stream processing section that has been instructed to stop a clock stops at least one of clocks that are being used in the stream processing section.
